(19) United States
(12) Patent Application Publication
(10) Pub. No.: US 2022/0114611 A1
(43) Pub. Date: Apr. 14, 2022

(54) COUPON SYSTEM, COUPON MANAGEMENT DEVICE, AND CONTROL METHOD THEREOF

(71) Applicant: TOSHIBA TEC KABUSHIKI KAISHA, Tokyo (JP)

(72) Inventors: Toru TERAUCHI, Nerima Tokyo (JP); Kazunari KOGURE, Taito Tokyo (JP); Toshihide MURATA, Izunokuni Shizuoka (JP); Takuma TANAKA, Izunokuni Shizuoka (JP)

(21) Appl. No.: 17/463,440

(22) Filed: Aug. 31, 2021

(30) Foreign Application Priority Data
Oct. 8, 2020 (JP) 2020-170596

(51) Int. Cl. G06Q 30/02; G06Q 20/20; G06F 3/12

(52) U.S. Cl. CPC G06Q 30/0238; G06Q 20/202; G06F 16/22; G06F 3/1213; G06F 3/1243; G06Q 20/209

(57) ABSTRACT

A coupon management device includes a network interface configured to communicate with a payment terminal installed at a store, and a processor configured to upon receipt of transaction data of a transaction settled by the payment terminal and identification information associated with the store, select one or more coupons based on the transaction data, based on the identification information, determine a number of coupons to be issued from the payment terminal, generate print data of the determined number of coupons among the selected coupons, and control the network interface to transmit the generated print data to the payment terminal.

### CROSS-REFERENCE TO RELATED APPLICATION

This application is based upon and claims the benefit of priority from Japanese Patent Application No. 2020-170596, filed Oct. 8, 2020, the entire contents of which are incorporated herein by reference.

### FIELD

Embodiments described herein relate to a coupon system, a coupon management device included in the system, and a method performed thereby.

### BACKGROUND

A coupon system that issues sales promotion coupons provided by manufacturers to customers via payment terminals in retail stores such as Point Of Sales (POS) terminals, is known. Such a coupon system includes a coupon server that manages data related to the coupons. The payment terminals installed in retail stores are connected to the coupon server. In each payment terminal, when a transaction is settled by a customer, transaction data is generated and transmitted to the coupon server via a network. The coupon server stores the transaction data and then transmits to the payment terminal the data for a coupon that satisfies predetermined issuance conditions related to the transaction data. The payment terminal prints out the coupon on receipt paper, for example, when printing a sales receipt.

Such a coupon system sometimes requires a waiting time to complete the issuance or printing of the coupon after the transaction has been settled at the payment terminal. If the waiting time is long, not only the customer but also the operator of the payment terminal may feel concern, stress, or discomfort due to the waiting. The length of the waiting time primarily depends on conditions of networks between the payment terminal and the coupon server. Generally, there can be a plurality of types of networks in the communication path between the payment terminal and the coupon server. If a network with a slow communication speed is utilized for at least a portion of the communication path, the waiting time becomes longer. Thus, there is a demand for a coupon system capable of reducing a waiting time for issuing a coupon, thereby a customer and a clerk do not feel stressed by delay in coupon/receipt issuance.

### BRIEF DESCRIPTION OF THE DRAWINGS

FIG. 1 depicts a schematic diagram of a coupon system according to an embodiment.

FIG. 2 depicts a data structure of a coupon record stored in a coupon database.

FIG. 3 depicts a block diagram of a coupon server.

FIG. 4 depicts a data structure of a setting table according to a first embodiment.

FIG. 5 depicts a block diagram of a POS terminal.

FIG. 6 depicts flowcharts of information processes performed by a POS terminal and a coupon server.

FIG. 7 depicts a data structure of a setting table according to a second embodiment.

FIG. 8 depicts flowcharts of information processes performed by a POS terminal and a coupon server.

FIG. 9 depicts a data structure of an update table according to a third embodiment.

FIG. 10 depicts flowcharts of information processes performed by a POS terminal and a coupon server.

FIG. 11 depicts a flowchart of an update process performed by a coupon server.

### DETAILED DESCRIPTION

One or more embodiments provide a device and a method for reducing a waiting time of issuing a coupon.

In general, according to one embodiment, a coupon management device includes a network interface configured to communicate with a payment terminal installed at a store, and a processor configured to upon receipt of transaction data of a transaction settled by the payment terminal and identification information associated with the store, select one or more coupons based on the transaction data, based on the identification information, determine a number of coupons to be issued from the payment terminal, generate print data of the determined number of coupons among the selected coupons, and control the network interface to transmit the generated print data to the payment terminal.

Hereinafter, a plurality of embodiments are described with reference to the drawings. The embodiments described below relate to a coupon system that provides a customer with a sales promotion coupon managed by a coupon management device using a payment terminal installed in a store of a supermarket chain, a convenience store chain, or the like.

### First Embodiment

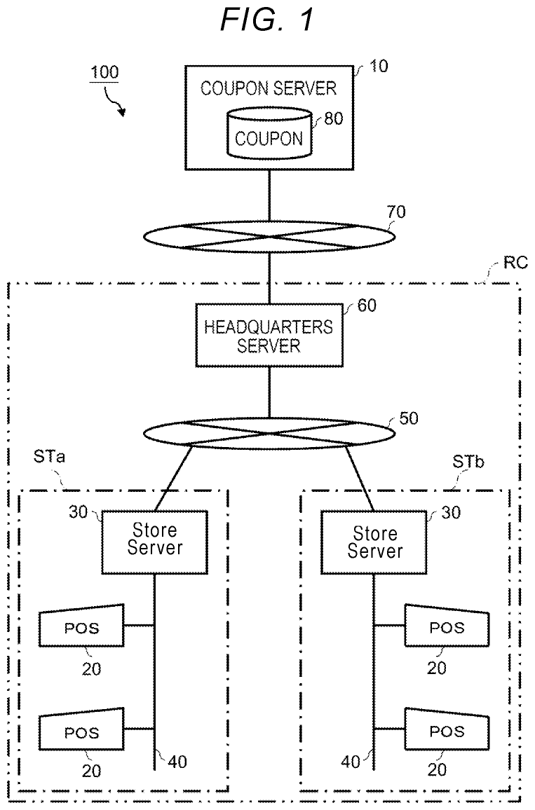

First, a first embodiment is described with reference to FIGS. 1 to 6.

FIG. 1 depicts a schematic diagram of a coupon system 100 according to the first embodiment. The coupon system 100 includes a coupon server 10 and a plurality of POS terminals 20. The coupon server 10 is an example of a coupon management device that manages data of a sales promotion coupon. The POS terminals 20 are examples of payment terminals that are installed in stores STa and STb operated by a retail corporation RC.

A store server 30 and one or more of the POS terminals 20 are installed in each of the stores STa and STb. The store servers 30 and the POS terminals 20 are connected to an in-store network 40. The in-store network 40 is typically a wired or wireless Local Area Network (LAN). The in-store network 40 may be a communication network other than LAN.

The POS terminal 20 has functions of registering sales data of merchandise (e.g., a price) purchased by a customer in a memory and settling a merchandise sales transaction. In case of settlement, the POS terminal 20 prints a receipt indicating details of the transaction. In addition, the POS terminal 20 may print a sales promotion coupon.

The store server 30 has a function of managing data relating to the sales of each of the stores STa and STb by collecting and totaling the data of the transaction settled by each POS terminal 20 connected by the in-store network 40.

The store servers 30 of the stores STa and STb are connected to a headquarters server 60 installed in the headquarters of the retail corporation RC via an intranet 50. The headquarters server 60 is an information processing device having a function of managing data relating to the sales of the entire retail corporation RC by collecting and totaling data relating to the sales managed by the store servers 30. The intranet 50 is typically formed by a dedicated digital line, an Integrated Services Digital Network (ISDN) line, or the like. The intranet 50 may be formed by other communication networks.

The headquarters server 60 is connected to the coupon server 10 via an external network 70. The coupon server 10 is an information processing device that provides a coupon distribution service by using cloud computing. The external network 70 is, for example, the Virtual Private Network (VPN) or the wide area Ethernet®. The external network 70 may include the Internet, a mobile phone network, or the like.

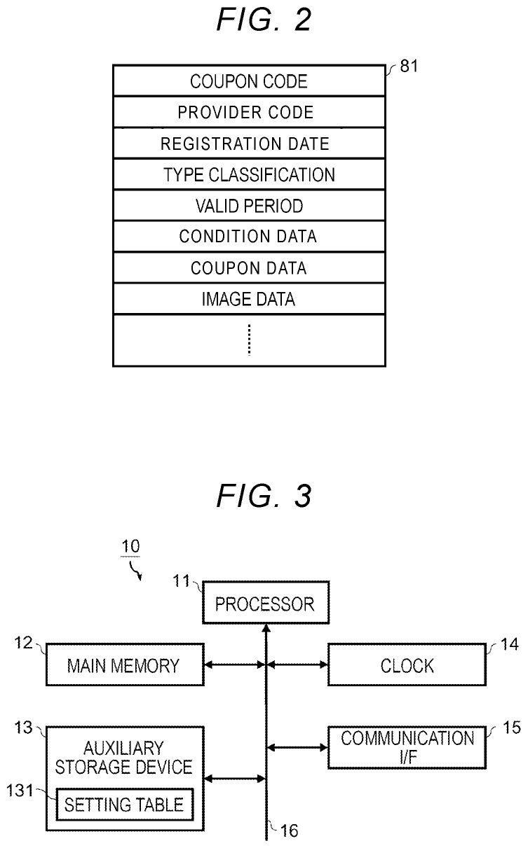

The coupon server 10 includes a coupon database 80. The coupon database 80 is a collection of coupon records 81 (see FIG. 2). The coupon record 81 is generated for each sales promotion coupon provided by a manufacturer, a retail corporation, or the like.

FIG. 2 depicts a data structure of the coupon record 81. The coupon record 81 includes a coupon code, a provider code, a registration date, a type classification, a valid period, condition data, coupon data, image data, and the like.

The coupon code is an identifier of the coupon record 81. A different coupon code is assigned to each of the coupon records 81. The provider code is a code for identifying a provider of the corresponding sales promotion coupon. The provider is typically a manufacturer of the merchandise. The provider may be a retail corporation, a local government, or the like. For example, the manufacturer provides a ticket to apply for a campaign via a website separately provided by the manufacturer as a sales promotion coupon. For example, the retail corporation provides a stamp card for collecting stamps, a discount coupon that can be applied to the next purchase, or the like as a sales promotion coupon for customers who shop at stores that belong to the retail corporation. In addition, the content of the sales promotion coupon is not limited thereto. Anything that can result in a sales promotion effect to customers may be used as the sales promotion coupon.

The registration date is a date when the sales promotion coupon is registered in the coupon database 80. The type classification is data for identifying a type of the sales promotion coupon. As described above, there are various types of application tickets, stamp cards, discount coupons or the like, as the sales promotion coupon.

The valid period is defined by start and end dates between which the promotional coupon is valid. The valid period may be defined by a start date and the number of days from the start date to the end date. The condition data indicates one or more conditions for issuing the promotional coupon. The conditions are defined based on the transaction contents. Examples of the conditions include a transaction amount, a purchased item or product, the quantity of purchased merchandise, a customer's attribute, and his or her membership status.

The coupon data indicates the contents of the sales promotion coupon. For example, in case of the application ticket, particular data required to apply for the promotion or the like is the coupon data. For example, in case of the stamp card, data relating to the stamp or the like is the coupon data. In case of the discount coupon, data relating to the discount rate, the merchandise to be discounted or the like is the coupon data. The image data represents an image of the sales promotion coupon. The coupon is printed based on the coupon data and the image data described above.

In addition, in FIG. 1, only one headquarters server 60 connected to the external network 70 is illustrated, but the headquarters servers 60 of the other retail corporations RC may be connected to the external network 70. In addition, only two store servers 30 connected to the intranet 50 are illustrated, but a plurality of store servers 30 of other stores may be connected to the intranet 50.

In the coupon system 100, if a transaction is settled by the POS terminal 20 for a customer, the transaction data is transmitted to the coupon server 10 via the in-store network 40, the intranet 50, and the external network 70.

The coupon server 10 searches the coupon database 80 for a record that matches the transaction data. As a result, among the coupon records 81 within the valid period, the coupon record 81 that satisfies the conditions is detected, the coupon server 10 generates print data of the sales promotion coupon using the coupon data and the image data of the coupon record 81 thereof. At this time, if there are two or more coupon records 81 that satisfy the conditions, the coupon server 10 generates as much print data of the sales promotion coupons as possible within the range of the maximum number of sheets N described below.

The coupon server 10 transmits the print data of the sales promotion coupon to the POS terminal 20 via the external network 70, the intranet 50, and the in-store network 40. The POS terminal 20 prints the print data of the sales promotion coupon on the receipt paper with a printer 28 for printing a receipt (see FIG. 5). Thus, in the coupon system 100, the sales promotion coupon corresponding to the content of the transaction settled by the POS terminal 20 is printed out from the corresponding POS terminal 20.

FIG. 3 depicts a block diagram of the coupon server 10. The coupon server 10 includes a processor 11, a main memory 12, an auxiliary storage device 13, a clock 14, and a communication interface 15. The processor 11, the main memory 12, the auxiliary storage device 13, the clock 14, and the communication interface 15 are connected to each other via a system bus 16. The system bus 16 includes an address bus, a data bus, and the like. For example, the coupon server 10 is a computer in which the processor 11, the main memory 12, the auxiliary storage device 13, the clock 14, and the communication interface 15 are connected via the system bus 16.

The processor 11 performs various functions of the coupon server 10 according to an operating system and/or one or more application programs. The processor 11 is, for example, a Central Processing Unit (CPU).

The main memory 12 includes a non-volatile memory area and a volatile memory area. The main memory 12 stores the operating system and/or the application programs in the non-volatile memory area. The volatile memory area of the main memory 12 stores various data required for the processor 11 to execute a process of controlling each component of the coupon server 10. In addition, the volatile memory area functions as a work area in which such data is temporarily stored by the processor 11. The non-volatile memory area is, for example, a Read Only Memory (ROM). The volatile memory area is, for example, a Random Access Memory (RAM).

The auxiliary storage device 13 is, for example, a well-known storage device such as a Solid State Drive (SSD), a Hard Disc Drive (HDD), or an Electric Erasable Programmable Read-Only Memory (EEPROM), or any combination thereof. The auxiliary storage device 13 stores various data to be used by the processor 11 for performing various processes, data generated during the processes being performed, or the like. The auxiliary storage device 13 may store one or more application programs.

The application programs stored in the main memory 12 and/or the auxiliary storage device 13 includes a control program described below. A method of installing the control program in the main memory 12 and/or the auxiliary storage device 13 is not particularly limited. The control program can be stored in the main memory 12 and/or the auxiliary storage device 13 by copying the control program from a removable recording medium or downloading the control program via a network. An example of the recording medium includes, but is not limited to, a CD-ROM or a memory card.

The clock 14 stores date and time data. The processor 11 acquires the current date and time from the clock 14.

The communication interface 15 is a network interface circuit such as a NIC (network interface card) configured to perform data communication with each headquarters server 60 of the retail corporations RC via the external network 70.

The coupon server 10 stores a setting table 131 in the auxiliary storage device 13.

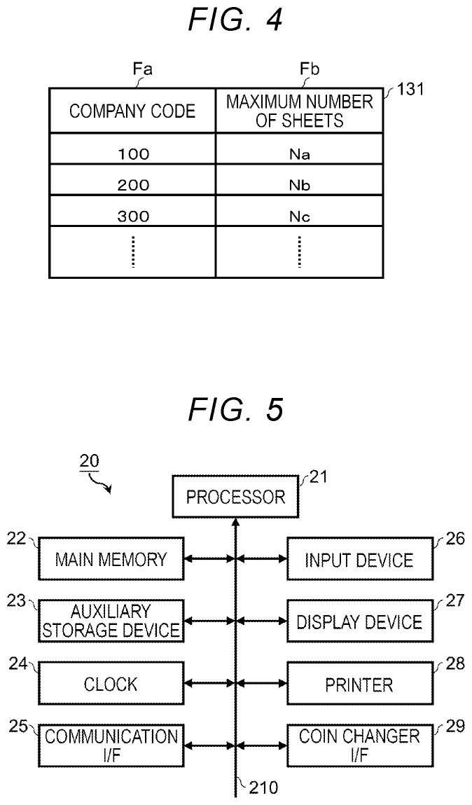

FIG. 4 depicts a data structure of the setting table 131. As illustrated in FIG. 4, the setting table 131 includes a first field Fa in which a plurality of company codes are described and a second field Fb in which the maximum numbers of sheets N are described. The company code is a unique code set for each retail corporation RC in order to identify the retail corporation RC. The maximum number of sheets N is a maximum number of sales promotion coupons printed for a transaction settled by the POS terminals 20 of the stores STa and STb that belong to the retail corporation RC identified with the corresponding company code.

As described above, if a transaction is settled for a customer by the POS terminal 20 in the coupon system 100, the transaction data indicating the transaction content is transmitted to the coupon server 10. In the coupon server 10, one or more sales promotion coupons that satisfy the predetermined conditions based on the transaction data are acquired, and the print data thereof are generated. The print data of the sales promotion coupon are transmitted from the coupon server 10 to the POS terminal 20 and printed by the printer 28 (see FIG. 5) as the sales promotion coupons.

Accordingly, there is a waiting time after the transaction is settled by the POS terminal 20, until all of the sales promotion coupons are printed. This waiting time is time obtained by summing up transmission time of the transaction data, print data generation time of the sales promotion coupons, and transmission time of the print data. Among these kinds of time, the print data generation time depends on the number of the sales promotion coupons to be issued. That is, as the number of sheets to be issued increases, the print data generation time increases.

The transmission time for the transaction data and the print data depends on the network environment between the POS terminal 20 and the coupon server 10. That is, even when the same amount of data is transmitted, the transmission time is smaller in a network environment in which the communication speed is higher.

According to the present embodiment, the in-store network 40, the intranet 50, and the external network 70 are interposed between the POS terminal 20 and the coupon server 10. Among these, the external network 70 connects the coupon server 10 and each headquarters server 60 of the retail corporations RC to each other. Therefore, the network environment is common regardless of retail corporations RC. In contrast, the in-store network 40 and the intranet 50 are formed in each retail corporation RC. Therefore, the network environments thereof are different depending on the retail corporations RC. Therefore, even in case of printing the same sales promotion coupon, the waiting time becomes longer in a retail corporation RC with a poorer network environment.

For example, a waiting time Ta for printing one sheet of the sales promotion coupon is 1 second with the POS terminal 20 of the retail corporation RC having an ideal network environment, but is 2.5 seconds with the POS terminal 20 of the retail corporation RC with a poor network environment. Here, if a waiting time Tb acceptable in a retail store is 5 seconds, the print data for five sales promotion coupons can be transmitted within 5 seconds in the ideal network environment. However, the print data only for two sales promotion coupons can be transmitted in the poor network environment.

Here, according to the present embodiment, the maximum number of sheets N is determined for each retail corporation RC by Equation (1) as below. Also, in correlation with the company code of each retail corporation RC, the maximum number of sheets N calculated for the retail corporation RC is set to the setting table 131.

N=Tb/Ta (1)

The digits after the decimal point are removed.

FIG. 5 depicts a block diagram of the POS terminal 20. The POS terminal 20 includes a processor 21, a main memory 22, an auxiliary storage device 23, a clock 24, a communication interface 25, an input device 26, a display device 27, the printer 28, and a coin changer interface 29. The processor 21, the main memory 22, the auxiliary storage device 23, the clock 24, the communication interface 25, the input device 26, the display device 27, the printer 28, and the coin changer interface 29 are connected via a system bus 210. The system bus 210 includes an address bus, a data bus, or the like. For example, the POS terminal 20 is a computer in which the processor 21, the main memory 22, the auxiliary storage device 23, the clock 24, and the communication interface 25 are connected via the system bus 210.

The processor 21 performs various functions as the POS terminal 20 according to an operating system and/or one or more application programs. The processor 21 is, for example, a CPU.

The main memory 22 includes a non-volatile memory area and a volatile memory area. The main memory 22 stores the operating system and/or the application programs in the non-volatile memory area. The volatile memory area of the main memory 22 stores various data required by the processor 21 to execute a process of controlling each component of the POS terminal 20. In addition, the volatile memory area functions as a work area in which such data is temporarily stored by the processor 21. The non-volatile memory area is, for example, a ROM. The volatile memory area is, for example, a RAM.

The auxiliary storage device 23 is, for example, a well-known storage device such as an SSD, an HDD, or an EEPROM, or any combination thereof. The auxiliary storage device 23 stores various data to be used by the processor for performing various processes, data generated by a process in the processor 21, or the like. The auxiliary storage device 23 may store one or more application programs.

The application programs stored in the main memory 22 and/or the auxiliary storage device 23 includes a control program described below. A method of installing the control program in the main memory 22 and/or the auxiliary storage device 23 is not particularly limited. The control program can be stored in the main memory 22 and/or the auxiliary storage device 23 by copying the control program from a removable recording medium or downloading the control program via a network. An example of the recording medium includes, but is not limited to, a CD-ROM or a memory card.

The clock 24 stores date and time data. The processor 21 acquires the current date and time from the clock 24.

The communication interface 25 is a network interface circuit such as a NIC configured to perform data communication with the store server 30 via the in-store network 40.

The input device 26 is a device used for inputting a merchandise code and the number of purchased items of a merchandise purchased by a customer, or the like, inputting price data to be paid by the customer, inputting data to be recorded in a card medium such as a points card (customer loyalty card), a member card, or an electronic money card, or the like. As the input device, a keyboard, a scanner, a card reader, or the like is used.

The display device 27 is a device for displaying merchandise names, prices, the total price, and the change amount, and the like of merchandises registered for sale. As the display device, a liquid crystal display, an organic EL display, or the like is used. In addition, a touch display including a touch panel may be used as the display device 27 having the function of the input device 26.

The printer 28 is a device that can print a receipt, a coupon, or the like on receipt paper. As the printer 28, a thermal printer, an inkjet printer, or the like is used.

The coin changer interface 29 is an interface for an automatic coin changer. The automatic coin changer is well-known, and thus the description thereof is omitted.

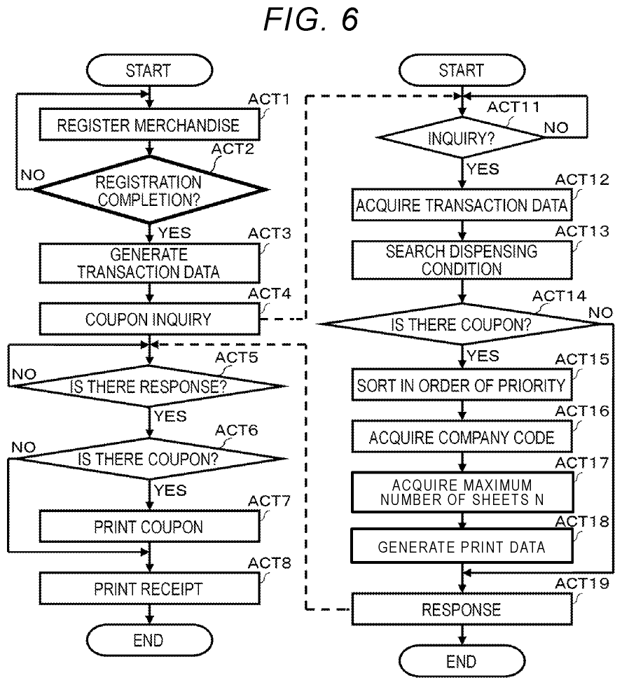

FIG. 6 depicts flowcharts of information processes performed by the POS terminal 20 and the coupon server 10. In FIG. 6, ACTS 1 to 8 illustrate a sequence of steps performed by the POS terminal 20, and ACTS 11 to 19 illustrate a sequence of steps performed by the coupon server 10. Hereinafter, with reference to FIG. 6, a main operation of the coupon system 100 is described. In addition, operations described below are examples. As long as the same effect can be obtained, a part of the sequence of the operations may be modified or omitted.

The processor 21 of the POS terminal 20 registers merchandise as ACT 1. Specifically, if a barcode of merchandise to be purchased by a customer is read by the input device 26 (e.g., a scanner), the processor 21 acquires, based on a merchandise code obtained from the barcode, merchandise data such as a price and the merchandise name of the merchandise from a merchandise file. The merchandise file is stored, for example, in the store server 30 connected via the in-store network 40. The processor 21 then generates merchandise sales data based on the merchandise data. Also, the processor 21 performs a process of registering the merchandise sales data in a transaction memory. The transaction memory is, for example, a portion of the volatile storage area of the main memory 12 and is initialized before the registration of the first merchandise of the customer starts.

The processor 21 that has finished the merchandise registration checks whether a registration completion is declared as ACT 2. If the registration completion is not declared, the processor 21 determines NO in ACT 2 and returns to ACT 1. The processor 21 registers the second merchandise.

If the clerk ends registration of merchandises to be purchased by the customer, the clerk declares the registration completion, for example, by operating the input device 26 (e.g., a keyboard). If the registration completion is declared, the processor 21 determines YES in ACT 2 and proceeds to ACT 3. The processor 21 generates transaction data based on the merchandise sales data stored in the transaction memory as ACT 3. In addition, the processor 21 controls the communication interface 25 to transmit a coupon inquiry command to the coupon server 10 as ACT 4.

According to this control, in the POS terminal 20, the coupon inquiry command is transmitted from the communication interface 25. The coupon inquiry command includes the generated transaction data, the company code of the company that operates the store, and its store code. The transaction data includes one or more merchandise codes, the number of purchased items by the customer, the total price, or the like. In addition, if a membership card of the customer is read by the input device 26 (e.g., a card reader), the data of the membership card is also included in the transaction data.

The company code is a code for identifying the retail corporation RC that operates the store STa and STb. The store code is a code for identifying the store STa or STb in which the POS terminals 20 are installed. That is, the company code and the store code are identification information correlated with the POS terminal 20. The company code and the store code are stored, for example, in the main memory 22 or the auxiliary storage device 23 of the POS terminal 20. The company code and the store code are stored, for example, in the store server 30, and may be added to or included in the coupon inquiry command transmitted from the POS terminal 20.

The coupon inquiry command is transmitted from the POS terminal 20 to the store server 30 via the in-store network 40, and is further transmitted to the headquarters server 60 via the intranet 50, and to the coupon server 10 via the external network 70.

Here, the processor 21 of the POS terminal 20 performs a process of ACT 4 in cooperation with the communication interface 25.

The processor 11 of the coupon server 10 waits for the coupon inquiry command as ACT 11. If the coupon inquiry command is received via the communication interface 15, the processor 11 determines YES in ACT 11 and proceeds to ACT 12. The processor 11 acquires the transaction data from the coupon inquiry command as ACT 12. Also, the processor 11 stores the transaction data in a collection and storage file. The collection and storage file is stored, for example, in the auxiliary storage device 13. The collection and storage file may be provided, for example, in the other server connected via the external network 70.

The processor 11 that has acquired the transaction data searches for the conditions of the sales promotion coupon using the transaction data. Specifically, among the coupon records 81 registered in the coupon database 80, the processor 11 extracts each coupon record 81 in which the current date and time obtained from the clock 14 is within the valid period thereof. Also, the processor 11 determines whether the transaction data satisfies the predetermined conditions specified by the condition data of the coupon record 81 thereof.

For example, in case of the coupon record 81 of which a condition is a transaction amount, it is determined that the transaction amount included in the transaction data is equal to or higher than the transaction amount indicated by the condition data. For example, in case of the coupon record 81 of which a condition is a purchased item, it is determined whether the sales data of the item is included in the transaction data. For example, in case of the coupon record 81 of which a condition is a customer's attribute, it is determined whether the customer attribute of the customer specified from the data of the membership card included in the transaction data is identical to the customer attribute indicated by the condition data.

As ACT 14, the processor 11 checks whether one or more records of the coupon records 81 that satisfy the conditions indicated by the condition data are obtained. If the coupon record 81 that satisfies the conditions is not acquired at all, the processor 11 determines NO in ACT 14 and proceeds to ACT 19. The sequence of processes subsequent to ACT 19 is described below.

If one or more records of the coupon records 81 that satisfy the conditions are acquired, the processor 11 sorts the acquired coupon records 81 as the ACT 15 in a descending order of priority. The order of priority is determined based on the provider code, the registration date, the type classification, or the like.

For example, with respect to the provider code of each provider, the order of priority is set in advance. In such a case, the processor 11 sorts the acquired coupon records in a descending order of priorities thereof. For example, the order is set so that the order of priority is higher as the registration date is older. In such a case, the processor 11 sorts the coupon records in a descending order of plan registration dates. For example, with respect to the type classification, the order of priority is set in advance. In such a case, the processor 11 sorts the coupon records in a descending order of priority thereof.

As ACT 16, the processor 11 acquires the company code from the coupon inquiry command. As ACT 17, the processor acquires the maximum number of sheets N set in correlation with the company code thereof from the setting table 131.

As ACT 18, the processor 11 generates print data of one or more sales promotion coupons. Specifically, among the coupon records 81 sorted in the order of priority in the process of ACT 15, the processor 11 selects the coupon records 81 in a descending order of priority until the number of sheets reaches the maximum number of sheets N. Also, the processor 11 generates print data of the sales promotion coupon using the coupon data and the image data corresponding to each of the selected coupon records 81.

The processor 11 that has generated the print data of the sales promotion coupons proceeds to ACT 19. In this manner, if the processor 11 generates the print data of the sales promotion coupons by the maximum number of sheets N from the coupon records 81 that satisfy the predetermined conditions or cannot acquire the coupon records 81 that satisfy the conditions at all, the processor 11 proceeds to ACT 19.

The processor 11 controls the communication interface 15 to transmit a response command in response to the coupon inquiry command as ACT 19. If any one coupon record 81 that satisfies the conditions can be acquired, the print data of the sales promotion coupon is included in the response command. If the coupon records 81 that satisfy the conditions cannot be acquired at all, information indicating that there is no coupon is included in the response command.

The response command is transmitted to the headquarters server 60 via the external network 70, further transmitted to the store server 30 via the intranet 50, and further transmitted to the POS terminal 20 via the in-store network 40.

Here, the processor 11 of the coupon server 10 performs the processes of ACTS 11 and 12 in cooperation with the communication interface 15. The processor 11 performs the processes of ACTS 16 and 17 with reference to the setting table 131. In addition, the processor 11 performs processes of ACTS 13 to 15 and ACT 18 with reference to the coupon database 80. Further, the processor 11 performs a process of ACT 19 in cooperation with the communication interface 15.

As ACT 5, the processor 21 of the POS terminal 20 that controls the transmission of the coupon inquiry command waits for the response command from the coupon server 10. If the response command is received via the communication interface 15, the processor 21 determines YES in ACT 5 and proceeds to ACT 6. As ACT 6, the processor 21 checks whether the print data of one or more sales promotion coupons is included in the response command.

If the print data of one or more sales promotion coupons is included in the response command, the processor 21 determines YES in ACT 6 and proceeds to ACT 7. As ACT 7, the processor 21 controls the printer 28 to print the print data of the sales promotion coupons. According to this control, the printer 28 operates to print the print data of the sales promotion coupons on receipt paper. Thus, the sales promotion coupons are dispensed from the POS terminal 20.

Here, the processor 21 performs the processes of ACTS 5 to 7 in cooperation with the communication interface 25 and the printer 28.

The processor 21 ends the process of ACT 7 and proceeds to ACT 8. If no print data for any sales promotion coupon is included in the response command, or if information is included indicating that there is no coupon, the processor determines NO in ACT 6. The processor 21 skips the process of ACT 7 and proceeds to ACT 8.

As ACT 8, the processor 21 controls the printer 28 to print the transaction data. According to the control, the printer 28 operates, to print the transaction data on the receipt paper. Thus, a receipt indicating the details of the transaction is dispensed from the POS terminal 20. In the above, the main operation sequences of the processor 21 of the corresponding POS terminal 20 and the processor 11 of the coupon server 10 with respect to the transaction performed by the POS terminal 20 end.

As described above, according to the first embodiment, if the number of sales promotion coupons that satisfy predetermined conditions exceeds the maximum number of sheets N that is set in the setting table 131, print data of only the maximum number of the sales promotion coupons is transmitted and output from the coupon server 10 to the POS terminal 20 of the retail corporation RC identified by the company code.

Here, as described above, the maximum number of sheets N is a quotient of the waiting time Tb acceptable in the retail store which is divided by the waiting time Ta in which one sales promotion coupon is dispensed. That is, if the number of sales promotion coupons is equal to or less than the maximum number of sheets N, the waiting time Ta in the POS terminal 20 does not exceed the waiting time Tb acceptable in the retail store.

Also, the waiting time Ta in the POS terminal 20 depends on the network that connects the POS terminal 20 and the coupon server 10 to each other. Particularly, the waiting time Ta depends on the network environment between the in-store network 40 and the intranet 50 in the retail corporation RC. That is, in case of the network environment in which the communication speed is high, the waiting time Ta becomes short. However, if the network environment in which the communication speed is slow is interposed, the waiting time Ta becomes long.

According to the present embodiment, for example, even in the store STa or STb of the retail corporation RC in which the network environment is poor and thus the waiting time Ta is long, the waiting time Ta does not exceed the acceptable waiting time Tb. Therefore, the consumer or the clerk can be prevented from feeling stressed.

In the store STa or STb of the retail corporation RC for which the network condition is satisfactory, and the waiting time Ta is short, more sales promotion coupons can be output within the range of the acceptable waiting time Tb. Therefore, the sales promotion using a coupon can be more effectively performed.

In addition, coupons are output in a descending order of priority. Therefore, for example, by setting an order of priority in a descending order of anticipated sales promotion effect, the sales promotion effect can be further enhanced.

### Second Embodiment

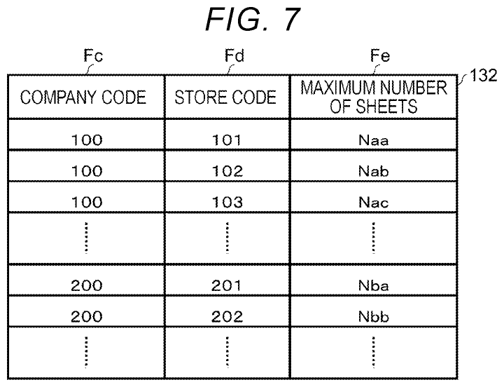

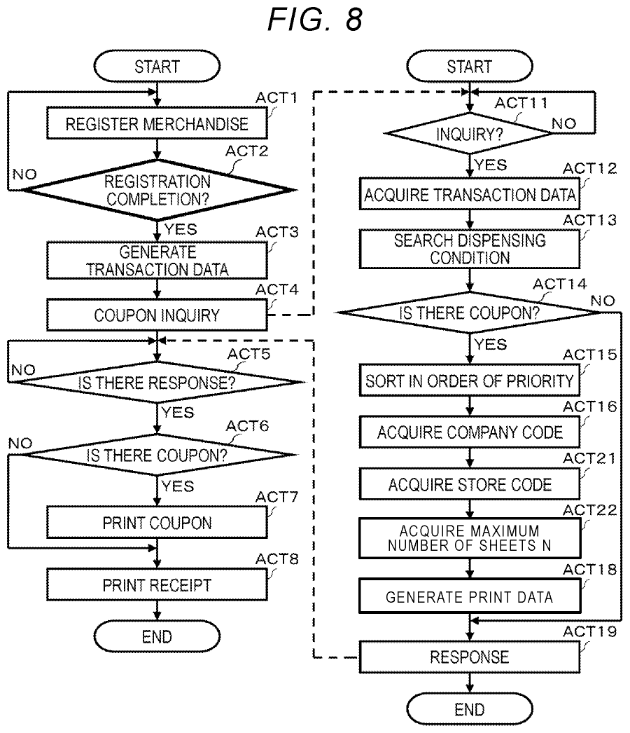

Subsequently, a second embodiment is described with reference to FIGS. 7 and 8. The differences between the second embodiment and the first embodiment are: the data structure of the setting table 131 stored in the coupon server 10; and the sequence of the information processes performed the coupon server 10. Accordingly, FIGS. 1, 2, 3, and 5 described in the first embodiment are used in the second embodiment without changes, and thus the description of each figure is omitted.

FIG. 7 depicts a data structure of the setting table 132 according to the second embodiment. The setting table 132 illustrated in FIG. 7 includes a first field Fc in which a plurality of company codes are described, a second field Fd in which store codes are described, and a third field Fe in which the maximum numbers of sheets N are described. The company code is a unique code assigned to each retail corporation RC in order to identify it. The store codes are unique codes assigned to stores (e.g., the stores STa and STb) belong to one of the retail corporations RC identified by the corresponding company code. The maximum number of sheets N is the maximum number of sales promotion coupons that can be printed with respect to a transaction settled by the POS terminals 20 of each store identified by the corresponding store code.

As described in the first embodiment, the waiting time Ta for sales promotion coupons to be printed after a transaction is settled by the POS terminal 20 depends on the network environment in which the POS terminal 20 and the coupon server 10 are connected to each other. Also, the in-store network 40, the intranet 50, and the external network 70 are interposed between the POS terminal 20 and the coupon server 10. Among these, the external network 70 is a communication network that connects the coupon server 10 to the headquarters server 60 of each retail corporation RC. Therefore, the network environment is common regardless of the retail corporations RC. In contrast, the in-store network 40 and the intranet 50 are designed and formed by each retail corporation RC. Therefore, the network environments thereof are different depending on the retail corporations RC. Also, even in case of the stores STa and STb that belong to the same retail corporation RC, the environments of the in-store networks 40 are different. For example, there is a tendency in that a store with more transactions has larger traffic volumes than a store with less transactions and thus takes a longer waiting time Ta.

Here, according to the present embodiment, by Equation (1), the maximum number of sheets N is determined for each of the stores STa and STb of the retail corporation RC. Also, in correlation with the company code of each retail corporation RC and the store codes the stores STa and STb that belong to the retail corporation RC, the maximum numbers of sheets N calculated with respect to the stores STa and STb are set in the setting table 132.

FIG. 8 depicts flowcharts of information processes performed by the POS terminal 20 and the coupon server 10. The processes common to those in FIG. 6 according to the first embodiment are denoted by the same reference numerals.

As clearly understood with the comparison between FIGS. 6 and 8, the second embodiment is different from the first embodiment, in that the processor 11 of the coupon server 10 performs processes of ACTS 21 and 22 between the process of ACT 16 and the process of ACT 18. That is, as ACT 21, the processor 11 acquires the store code from the coupon inquiry command from which the company code is acquired in ACT 16. Also, the processor 11 acquires the maximum number of sheets N set in correlation with the company code and the store code thereof as ACT 22, from the setting table 132.

If the process of ACT 22 ends, the processor 11 proceeds to ACT 18. That is, the processor 11 generates print data of one or more sales promotion coupons and controls the communication interface 15 to transmit the response command including the print data to the POS terminal 20.

In this manner, the print data of the sales promotion coupons, the number of which is less than or equal to the maximum number of sheets N, is transmitted and output from the coupon server 10 to the POS terminal 20 of the store STa or STb of the retail corporation RC. The store Sta or STb and the retail corporation RC are identified by the store code and the company code included in the coupon inquiry command, respectively.

As a result, the number of sales promotion coupons output from the POS terminal 20 of each of the stores STa and STb does not exceed the maximum number of sheets N set with respect to the stores STa and STb. Accordingly, in the stores STa and STb, the actual waiting time for the sales promotion coupons to be printed after the transaction is settled does not exceed the acceptable waiting time Tb. Accordingly, even when the network environments of the in-store networks 40 in the stores STa and STb that belong to the same retail corporation RC are different from each other, the same effect as in the first embodiment can be achieved.

### Third Embodiment

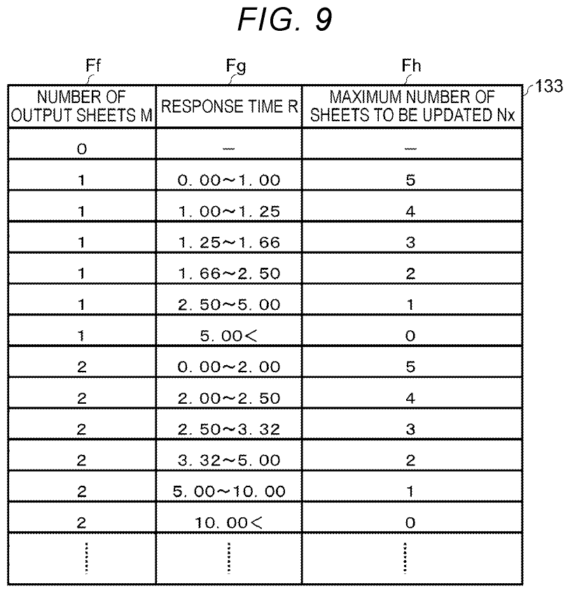

Subsequently, a third embodiment is described by using FIGS. 9 to 11. The differences between the third embodiment and the second embodiment are: the sequence of the information processes performed by the POS terminal 20 and the coupon server 10, and an update table 133 stored in and referred to by the coupon server 10 to periodically perform an update process.

FIG. 9 depicts a data structure of the update table 133. The update table 133 includes a first field Ff in which the numbers of output sheets M are described, a second field Fg in which response times R are described, and a third field Fh in which the numbers of sheets to be updated Nx are described.

The number of output sheets M is the number of sales promotion coupons included in a response command output from the coupon server 10 in response to a coupon inquiry command. In a case where information indicating that there is no coupon is included in the response command, the number of output sheets M is “0”. The response time R is a time between when the transaction is settled in the POS terminal 20 and when the response command is received by the POS terminal 20. The number of sheets to be updated Nx is the maximum number of sheets that can be output within the waiting time Tb in consideration of the number of output sheets M and the response time R.

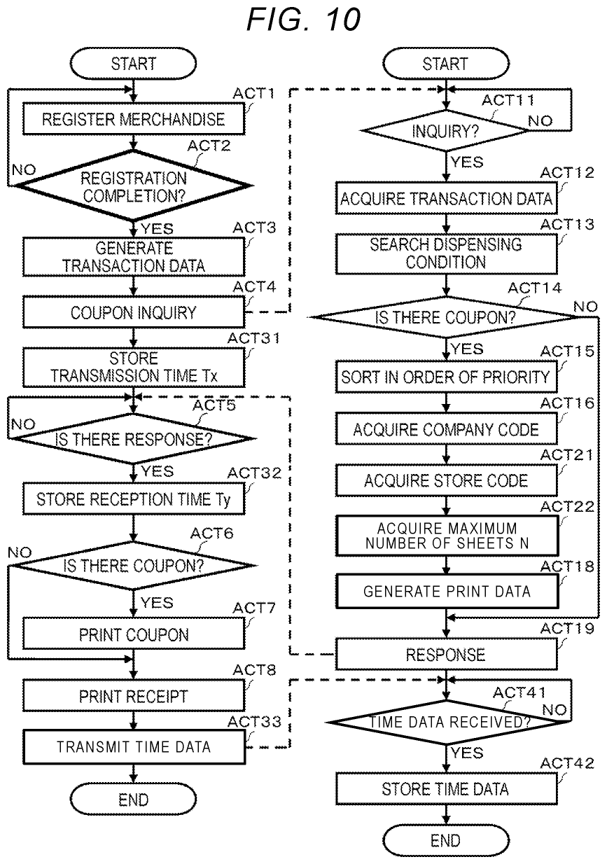

FIG. 10 depicts flowcharts of information processes performed by the POS terminal 20 and the coupon server 10. In addition, the processes common to those in FIG. 8 according to the second embodiment are denoted by the same reference numerals.

As clearly understood from the comparison between FIGS. 8 and 10, according to the third embodiment, after the POS terminal 20 transmits a coupon inquiry command as ACT 4, as ACT 31, the processor 21 stores the current time obtained from the clock 24 as a transmission time Tx.

Thereafter, the processor 21 waits for a response command from the coupon server 10 as ACT 5. Also, if the response command is received, the processor 21 determines YES in ACT 5 and proceeds to ACT 32. As ACT 32, the processor 21 stores the current time obtained from the clock 24 as a reception time Ty.

Thereafter, the processor 21 performs the processes of ACTS 6 to 8 in the same manner as described above. Then, if the receipt printing is controlled as ACT 8, the processor 21 controls the communication interface 25 to transmit time data to the coupon server 10 as ACT 33.

According to this control, the time data is transmitted from the communication interface 25. The transmission time Tx and the reception time Ty described above are included in the time data. In addition, in the same manner as in the coupon inquiry command, the company code and the store code are included. Further, the number of output sheets M of the sales promotion coupons obtained from the response command with respect to the coupon inquiry command is included.

After outputting a response command as ACT 19, the processor 11 of the coupon server 10 proceeds to ACT 41. The processor 11 waits for the time data as ACT 41. Also, if the time data is received via the communication interface 15, the processor 11 stores the time data in a data file as ACT 42. The data file is stored, for example, in the auxiliary storage device 13. The data file may be stored, for example, in the volatile memory area in the main memory 12. In the data file, a plurality of time data are stored in chronological order, for example, in the order of the transmission time Tx.

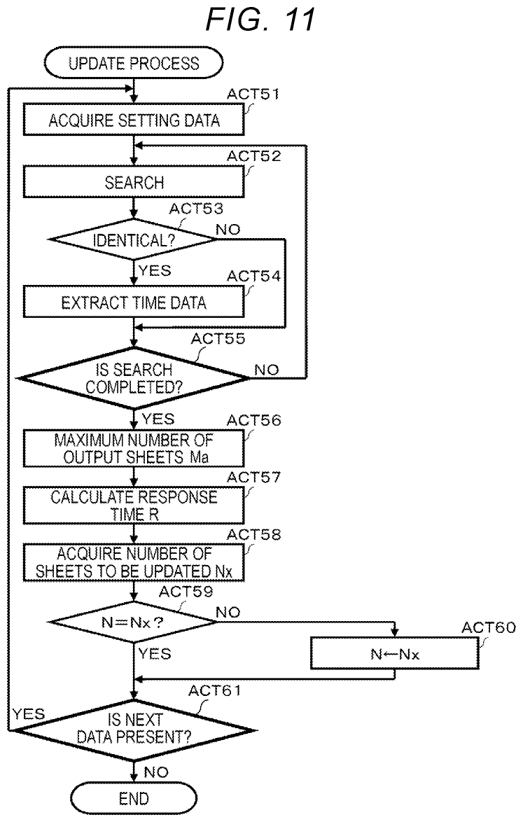

FIG. 11 depicts a flowchart of an update process performed by the coupon server 10. Hereinafter, the main operation according to the update process is described with reference to FIG. 11. In addition, operations described below are examples. As long as the same effect can be obtained, a part of the operations may be modified or omitted.

The processor 11 executes the update process, for example, every one minute by obtaining the current time from the clock 14. First, the processor 11 acquires the first record from the setting table 132, that is, a company code, a store code, the maximum number of sheets N as ACT 51.

Subsequently, the processor 11 searches the data file in which the time data is stored in a descending order of the transmission time Tx as ACT 52. Also, the processor 11 checks whether the company code and the store code of the time data are identical to the company code and the store code acquired from the setting table 132 as ACT 53. If the company code and the store code are identical, the processor 11 determines YES in ACT 53 and proceeds to ACT 54. The processor 11 stores the time data in an extraction memory as ACT 54. The extraction memory is a portion of the volatile memory area in the main memory 12.

The processor 11 checks whether the search of the data file ends as ACT 55. For example, if time data, for example, in which the transmission time Tx is a predetermined time earlier than the current time, is found, the processor 11 determines that the search has ended. The predetermined time is, for example, 60 minutes. The predetermined time may be any time other than 60 minutes.

If the search of the data file has not ended, the processor 11 determines NO in ACT 55 and returns to ACT 52. Also, the processor 11 performs the processes subsequent to ACT 52 as described above.

Accordingly, in the extraction memory, among the latest time data in which the transmission time Tx is within the predetermined time, the time data in which the company code and the store code are identical to the company code and the store code acquired from the setting table 132 is collected and stored.

If determining that the search of the data file has ended (YES in ACT 55), the processor 11 proceeds to ACT 56. As ACT 56, the processor 11 counts the number of the time data that have been collected and stored in the extraction memory and in which the numbers of output sheets M are identical. Also, the processor 11 acquires the number of output sheets M in which the count value is the maximum as the maximum number of output sheets Ma. If there are two or more numbers of output sheets M in which the count value is the maximum, for example, the largest number of output sheets M is selected as the maximum number of output sheets Ma.

The processor 11 calculates the response time R as ACT 57. That is, the processor 11 calculates the elapsed time from the transmission time Tx to the reception time Ty for each time data having the maximum number of output sheets Ma, and determines the average time thereof as the response time R.

As ACT 58, the processor 11 refers to the update table 133 and acquires the number of sheets to be updated Nx associated with the maximum number of output sheets Ma and the response time R. As ACT 59, the processor 11 checks whether the number of sheets to be updated Nx is identical to the maximum number of sheets N of the setting data acquired from the setting table 132. If the numbers are not identical to each other, the processor 11 determines NO in ACT 59 and proceeds to ACT 60. As ACT 60, the processor 11 rewrites the maximum number of sheets N of the setting data acquired from the setting table 132 to the number of sheets to be updated Nx. In contrast, if the number of sheets to be updated Nx is identical to the maximum number of sheets N, the processor 11 skips the process of ACT 60.

Thereafter, the processor 11 checks whether the next record is present in the setting table 132 as ACT 61. If present, the processor 11 determines YES in ACT 61 and returns to ACT 61. That is, the processor 11 acquires the next record (a company code, a store code, and a maximum number of sheets N) from the setting table 132 and performs the processes subsequent to ACT 52 as described above.

In this manner, with respect to the setting data stored in the setting table 132, if the processes subsequent to ACT 52 are performed, the processor 11 determines NO in ACT 61 and ends the update process.

According to the third embodiment, the maximum numbers of sheets N set for each company code and each store code in the setting table 132 can be updated to an optimum value in response to the current network environment in each of the stores STa and STb of the retail corporation RC identified by the company code and the store codes. Accordingly, for example, when the network is congested, the maximum number of sales promotion coupons that can be printed is reduced. In contrast, when the network is not congested, the maximum number of sales promotion coupons that can be printed is increased. Thus, even if the network condition fluctuates depending on time periods of a day or the like, the coupon system 100 can output more sales promotion coupons within the acceptable waiting time Tb.

As above, the first to third embodiments are described, but the embodiments are not limited thereto.

For example, according to the embodiments, a case where the POS terminal 20 prints a receipt and one or more sales promotion coupons is exemplified, but the receipt and the sales promotion coupons may not be necessarily printed. In the form of a so-called electronic receipt or electronic coupon, the receipt and the sales promotion coupons may be transmitted to and displayed by a communication terminal such as a smartphone owned by a customer. Even in such a case, the waiting time until the electronic coupon data is transmitted to and displayed by the communication terminal can be limited to a time that is not stressful.

According to the first and second embodiments, the maximum number of sheets N is determined for each retail corporation RC by Equation (1). However, the maximum number of sheets N is not necessarily limited to the value calculated by Equation (1). The maximum number of sheets N may be any value smaller than the value calculated by Equation (1).

In the embodiments, a case where the coupon server 10 is connected to the store server 30 and further to the POS terminal 20 via the headquarters server 60 is exemplified. Alternatively, the coupon server 10 may be connected to the store server 30 and further to the POS terminal 20 without the headquarters server 60. That is, the external network 70 and the intranet 50 are connected to a router, and the coupon server 10 may communicate with the store server 30 and also with the POS terminal 20 via the external network 70 and the intranet 50. Otherwise, the store server 30 may be omitted so that the coupon server 10 communicates directly with the POS terminal 20.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A coupon management device, comprising:
a network interface configured to communicate with a payment terminal installed at a store; and
a processor configured to:
upon receipt of transaction data for a transaction settled at the payment terminal and identification information associated with the store, select one or more coupons based on the transaction data,
based on the identification information, determine a number of coupons to be issued from the payment terminal,
generate print data for the determined number of coupons among the selected coupons, and
control the network interface to transmit the generated print data to the payment terminal.

2. The coupon management device according to claim 1, wherein the processor is further configured to sort the selected coupons according to a set priority.

3. The coupon management device according to claim 1, wherein the identification information identifies an operator that operates the store.

4. The coupon management device according to claim 3, further comprising:
a memory that stores the identification information in association with the number of coupons to be issued, wherein
the processor determines the number of coupons to be issued by searching the memory for the number of coupons associated with the identification information received from the payment terminal.

5. The coupon management device according to claim 4, wherein the processor is further configured to update the number of coupons stored in the memory in response to a change in a condition of a network between the payment terminal and the coupon management device.

6. The coupon management device according to claim 5, wherein the condition includes a time between when a transaction is settled by the payment terminal and when print data is received by the payment terminal.

7. The coupon management device according to claim 1, further comprising:
a memory that stores coupon data of a plurality of coupons each associated with a condition for the coupon to be selected, wherein
the processor is further configured to search the memory for one or more coupons each associated with the condition that matches the transaction data.

8. The coupon management device according to claim 7, wherein
each of the coupons is further associated with image data, and
the generated print data includes the image data of the determined number of coupons.

9. The coupon management device according to claim 1, further comprising:
a memory that stores a plurality of identification information for stores that are each associated with a number of coupons to be issued from a payment terminal at the store, wherein
the processor determines the number of coupons to be issued from the payment terminal by searching the memory for the number of coupons associated with the identification information received from the payment terminal.

10. The coupon management device according to claim 1, wherein the number of coupons to be issued from the payment terminal is determined based on a time for one coupon to be printed from the payment terminal and an acceptable waiting time after the transaction is settled.

11. A coupon system, comprising:
a payment terminal at a store and configured to settle a transaction and output transaction data for the transaction together with identification information associated with the store; and
a coupon management device including:
a network interface configured to communicate with the payment terminal, and
a processor configured to:
upon receipt of the transaction data and the identification information, select one or more coupons based on the transaction data,
based on the identification information, determine a number of coupons to be issued from the payment terminal,
generate print data for the determined number of coupons among the selected coupons, and
control the network interface to transmit the generated print data to the payment terminal.

12. The coupon system according to claim 11, wherein the processor is further configured to sort the selected coupons according to a set priority.

13. The coupon system according to claim 11, wherein the identification information identifies an operator that operates the store.

14. The coupon system according to claim 13, wherein
the coupon management device further includes a memory that stores the identification information in association with the number of coupons to be issued, and
the processor determines the number of coupons to be issued by searching the memory for the number of coupons associated with the identification information received from the payment terminal.

15. The coupon system according to claim 14, wherein the processor is further configured to update the number of coupons stored in the memory in response to a change in a condition of a network between the payment terminal and the coupon management device.

16. The coupon system according to claim 15, wherein the condition includes a time between when a transaction is settled by the payment terminal and when print data is received by the payment terminal.

17. The coupon system according to claim 11, wherein
the coupon management device further includes a memory that stores coupon data of a plurality of coupons each associated with a condition for the coupon to be selected, and
the processor is further configured to search the memory for one or more coupons each associated with the condition that matches the transaction data.

18. The coupon system according to claim 17, wherein
each of the coupons is further associated with image data, and
the generated print data includes the image data for the determined number of coupons.

19. The coupon system according to claim 11, wherein
the coupon management device further includes a memory that stores a plurality of identification information for stores that are each associated with a number of coupons to be issued from a payment terminal at the store, and
the processor determines the number of coupons to be issued from the payment terminal by searching the memory for the number of coupons associated with the identification information received from the payment terminal.

20. A method for coupon issuance management by a coupon management device, the method comprising:
upon receipt of transaction data of a transaction settled by a payment terminal at a store and identification information associated with the store, selecting one or more coupons based on the transaction data;
based on the identification information, determining a number of coupons to be issued from the payment terminal;
generating print data for the determined number of coupons among the selected coupons; and
transmitting the generated print data to the payment terminal.
